(19) United States
(12) Patent Application Publication
(10) Pub. No.: US 2026/0341062 A1
(43) Pub. Date: Oct. 29, 2026

(54) PROVIDING TEXT IN SCREEN SHARING

(71) Applicant: INTERNATIONAL BUSINESS MACHINES CORPORATION, ARMONK, NY (US)

(72) Inventors: Thomas James Baskerville, Eastleigh (GB); Jack Edward Dunning, Eastleigh (GB); Alvaro Rausell Guiard, Andover (GB); Aaron Tomor Robert Gashi, Chandler's Ford (GB)

(21) Appl. No.: 19/233,707

(22) Filed: Jun. 10, 2025

(30) Foreign Application Priority Data
Apr. 23, 2025 (GB) 2506046.8

(51) Int. Cl. G06V 30/12

(52) U.S. Cl. CPC G06V 30/133

(57) ABSTRACT

A method, computer program product, and computer system are provided for providing text in screen sharing. The method at a receiving computer system includes receiving screen sharing frames from a remote computer system; detecting a readability of text in a shared screen frame and determining if the readability in the shared screen frame is below a defined threshold; and, in response to determining that the shared screen frame is below the defined threshold, providing an output of text of the shared screen frame as received from the remote computer system. Based on a determination that the shared screen frame is above the defined threshold, the method displays the shared screen frame and iterates the method.

### BACKGROUND

The present invention relates to screen sharing for sharing information between computer systems, and more specifically, to providing text in screen sharing.

Screen sharing is used for collaborative working from computer systems at remote locations. One user at a computer system shares their screen presenting information for viewing by one or more other users from their computer systems. Screen sharing depends on a good and stable internet connection.

As an example, two users are working together over a screen share, programming in an integrated development environment or writing a text document together, but both have poor internet connections meaning the video quality is low and as a result the text on screen is not legible. Screen sharing applications may warn of poor network connection and disable video content entirely.

### SUMMARY

According to an aspect of the present invention there is provided a computer-implemented method for providing text in screen sharing, said method comprising: receiving, by a processor of a computer system, screen sharing frames from a remote computer system; detecting, by the processor of the computer system, a readability of text in the shared screen frame and determining if the readability in the shared screen frame is below the defined threshold; and, in response to determining that the shared screen frame is below the defined threshold, providing an output of text of the shared screen frame as received from the remote computer system.

According to another aspect of the invention there is provided a system for providing text in screen sharing, comprising: a viewer computer system having a processor and a memory configured to provide computer program instructions to the processor to execute a method of: receiving screen sharing frames from a remote computer system; detecting a readability of text in the shared screen frame and determining if the readability in the shared screen frame is below a defined threshold; and, in response to determining that the shared screen frame is below the defined threshold, providing an output of text of the shared screen frame as received from the remote computer system.

According to a further aspect of the present invention there is provided a computer program product for providing text in screen sharing, the computer program product comprising a computer readable storage medium having program instructions embodied therewith, the program instructions executable by a processor to cause the processor to: receive screen sharing frames from a remote computer system; detect a readability of text in a shared screen frame and determining if the readability in the shared screen frame is below a defined threshold; and in response to determining that the shared screen frame is below the defined threshold, provide an output of text of the shared screen frame as received from the remote computer system.

The computer readable storage medium may be a non-transitory computer readable storage medium and the computer readable program code may be executable by a processing circuit.

The present invention seeks to provide one or more concepts for providing text in screen sharing. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

### BRIEF DESCRIPTION OF THE DRAWINGS

Embodiments of the present invention will now be described, by way of example only, with reference to the accompanying drawings:

FIG. 1 is a block diagram of an example embodiment of a system in accordance with embodiments of the present invention;

FIG. 2 is a flow diagram of an example embodiment of a method in accordance with embodiments of the present invention;

FIG. 3 is a flow diagram of another example embodiment of a method in accordance with embodiments of the present invention;

FIG. 4 is a block diagram of an example embodiment of a system in accordance with embodiments of the present invention; and

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for providing text in screen sharing. Screen sharing is used in many applications where collaborative working is required. The described method and system provide a detection of the readability of text in shared screen frames received at a viewer's computer system and provide a fallback output at the viewer's computer system of text as provided by the presenting computer system.

This provides a fallback mechanism to allow a screen sharing application at the viewer's computer system to display text data during poor video quality in low bandwidth scenarios.

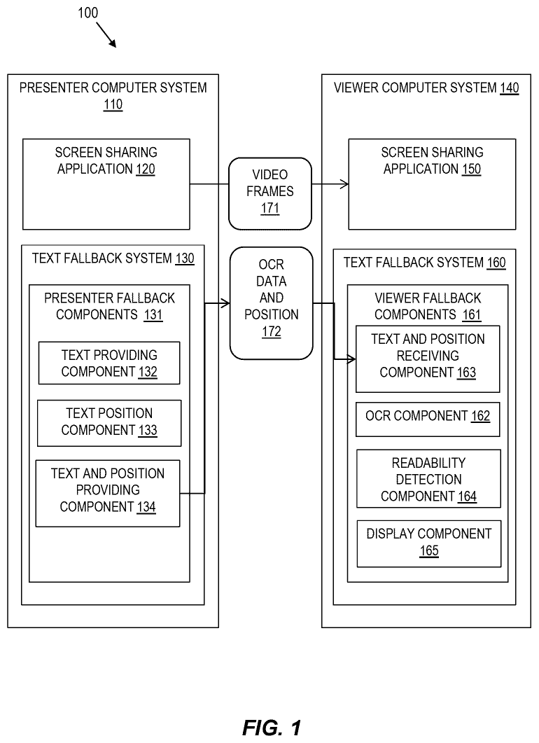

Referring to FIG. 1, an example embodiment of a computer environment 100 is shown in which a presenter computer system 110 uses a screen sharing application 120 for sharing video frames 171 with a remote viewer computer system 140 that uses a same screen sharing application 150.

The described system includes a text fallback system 130, 160 that is provided at the presenter computer system 110 and the viewer computer system 140. The text fallback system 130 may be integrated into a screen sharing application 120, 150 or provided as separate extension or stand-alone application. The text fallback system 130 may have functionality for both a presenter and for a viewer depending on a current role provided by a computer system. In FIG. 1 the different functionality is shown as presenter fallback components 131 at the presenter computer system 110 and viewer fallback components 161 at the viewer computer system 140 for illustration purposes.

The text fallback system 130 at the presenter computer system 110 includes presenter fallback components 131 including a text providing component 132 for providing text of video frames. The text providing component 132 may be an optical character recognition (OCR) component for either providing an OCR functionality or accessing an external OCR functionality to recognize text from video frames being presented by the screen sharing application 120. Alternatively, the text providing component 132 may access generated text of the video frame, such as from an editable version of the video frame as being presented at the presenter computer system 110. The presenter fallback components 131 also includes a text position component 133 for determining the position of the text elements in the video frames 171. The presenter fallback components 131 also includes a text and position providing component 134 for providing the text and text element positions 172 to the viewer computer system 140. In some embodiments, the position of text elements may not be provided by the presenter computer system 110 as this may be determined at the viewer computer system 140.

The text fallback system 160 at the viewer computer system 160 includes viewer fallback components 161 which includes a text and position receiving component 163 for receiving text, and, optionally, positions of text elements, from the presenter computer system 110.

The viewer fallback components 161 also include an OCR component 162 for either providing an OCR functionality or accessing an external OCR functionality to recognize text from video frames received by the screen sharing application 150. The OCR functionality may be the same as the OCR functionality used by the presenter computer system 110, if used. The viewer fallback components 161 also include a readability detection component 164 for determining a readability of text in the received video frames 171 of the screen sharing application 150 and for determining when to provide fallback text as described further below. The viewer fallback components 161 also include a display component 165 for displaying fallback text to the viewer.

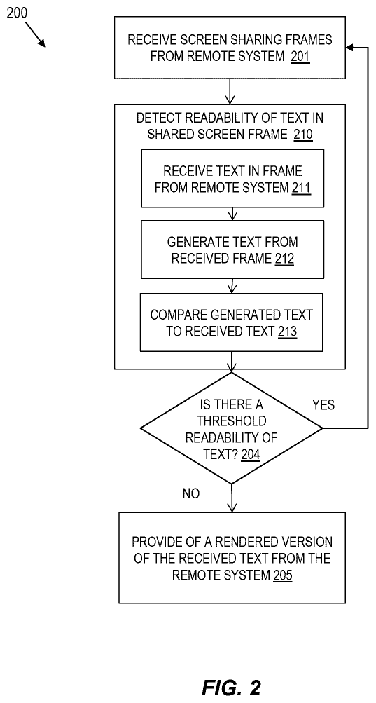

Referring to FIG. 2, a flow diagram 200 of an example embodiment of the described method for providing text display in screen sharing is shown. The method is described as carried out at a viewer computer system using a screen sharing application to view a presentation presented by a remote presenter computer system.

The method receives 201 screen sharing frames from the remote computer system. The method detects 210 a readability of text in a shared screen frame. The detection 210 may be carried out on selected key frames. The key frames may be at a configurable rate in the received frames. For example, the configurable rate may be every 0.5 seconds, every 2 seconds, or every 5 seconds.

The detection of readability may be carried out by various different methods. In the described embodiment, the detection of readability is carried out by comparing an OCR of text in a frame before transmission with an OCR of text in the received frame. The method may receive 211 text of a received screen sharing frame with the text generated by an OCR method applied to the frame before transmission and may generate 212 text of the received screen sharing frame with the text generated by the same OCR method as the received text of the frame. The OCR method used at the presenter end and the viewer end may be the same to give a strong comparison of OCR results.

The received text of the frame and the generated text of the frame may be compared 213 to determine a readability measure of the received frame. The comparison may use a detected word count to provide a readability measure.

As an example implementation, the method described in U.S. Pat. No. 10,638,168 (incorporated herein by reference) may be used as a readability measure. Essentially this patent covers using OCR on a video frame at 1080p, which may find 100 words for example, then repeating this for the same frame at 720p quality, then 480p, then 360p. Each time the number of words is compared to the 1080p (high quality) and when a threshold of word loss is met, e.g. 50% of words, the method makes the decision to stop creating lower quality resolutions of the video. i.e. 1080p (100 words), 720p (90 words), 480p (30 words) so system decides not to use 480p. In this disclosure, this method may be used to compare quality differences and determine a readability.

As an alternative to carrying out OCR at the presenter computer system, the actual text in a frame may be provided by the presenter computer system and compared to an OCR of text in the received frame.

As a further option, a sample of text from a frame may be processed to detect readability without carrying out an OCR processing of all the text of a frame. This is particularly relevant for the OCR process at the viewer computer system, where the OCR is only used for comparison purposes. The presenter computer system may carry out OCR on the full text of a frame or may provide the actual text via a non-OCR process.

It is determined 204 if the readability in a shared screen frame meets a defined threshold. When the threshold is met, the method may display the shared screen and loop to continue to receive 201 screen sharing frames and to continue to monitor by detecting the readability 210 of a next frame.

When a shared screen frame is below the defined threshold of readability, the method provides 205 an output of text of the shared screen as received from the remote computer system. This may replace the shared screen frame display.

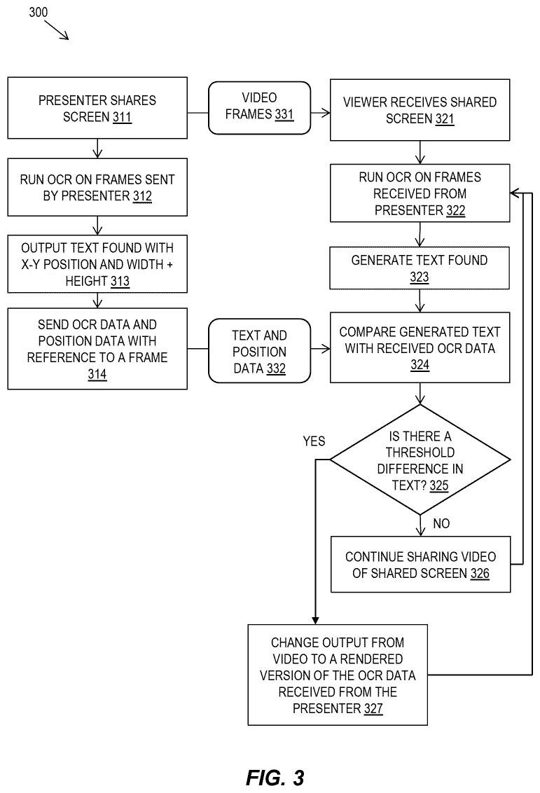

Providing an output of text of the shared screen as received from the remote computer system may include rendering the text in the output in text elements with positions corresponding to the text elements in the screen sharing frame as described further in relation to FIG. 3.

Referring to FIG. 3, a flow diagram 300 of another example embodiment of the described method for providing text display in screen sharing is shown. The method is described as carried out by a presenter computer system and a viewer computer system using a screen sharing application to view a presentation presented by the presenter computer system.

The presenter computer system shares 311 a screen and transmits screen sharing frames 331 to a receiving computer system that receives 321 and displays the shared screen. The transmission may be over a connection that has a variable bandwidth such that at times the connection has a low bandwidth resulting in a reduced clarity of the received and displayed frames.

The presenter computer system runs 312 an OCR method on the frames that are transmitted generating text of a screen sharing frame. The text generated at the presenter computer system is of high quality as the frame is at its original location and has not yet been transmitted. The position of text elements within the frame are found and the text is output 313 with an x, y coordinate of a reference position (which may be any agreed corner, such as a top left corner) and a height and width from the reference position.

The presenting computer system sends 314 the generated text and position data 332 in association with the screen sharing frame. This may send a text-based file (for example, a JavaScript Object Notation (JSON) file) with multiple entries with each entry having text and associated position data.

At the viewer computer system, the method runs 322 the OCR method on the frames received from the presenter computer system and generates 323 text found in the frames. The text generated by the viewer computer system may be of poorer quality due to a resolution of the shared screen frame being received over a poor bandwidth connection. The method compares 324 the generated text with the received OCR data from the presenter computer system.

It is determined 325 if the comparison of the OCR data shows a threshold difference in the text. If a threshold difference is not determined, the method continues sharing 326 video frames of the shared screen and continues monitoring the quality by the OCR text comparison. If the threshold difference is determined for a frame or a series of frames, the output is changed 327 from the shared screen video to a rendered version of the text data as received from the presenter computer system, rendered in the positional data. In this way, the viewer is able to read the text in the shared screen. The shared screen may continue to be monitored by the viewer computer system to determine when the text clarity improves such that the display can return to the shared screen frames.

In an example embodiment, before each frame of video is sent to the viewer computer system, the frame is processed using known techniques for OCR, to produce text data containing the text found in the video frame (image). For example, the image of the video frame may be 1080 pixel resolution at the presenter system. A position of text elements may also be determined that may include the x, y coordinates of that text and the height and width using known techniques. The combined text and position data may be sent as a file with X entries where each entry is a word/continuous line.

For example:
public void main [x: 100, y: 150, h: 10, w: 40]
void myMethod [x: 110, y: 170, h: 10, w: 35]
. . . many more snippets

As an example, in JSON, this may be an array of objects with details such as:

```
[
  {
    ″text″: ″public void main″,
    ″x″: 100,
    ″y″: 150,
    ″h″: 10,
    ″w″: 40
  },
  {
    ″text″: ″void myMethod″,
    ″x″: 110,
    ″y″: 170,
    ″h″: 10,
    ″w″: 35
  }
]
```

This text and position data may be sent alongside the video frame to all viewers. Each viewer computer system receives the text and position data and the video frame (image). Depending on the internet connection quality per user, the quality of the screen share video will vary.

The system running on the viewer's screen sharing application uses the same known techniques for OCR. The frame is processed to produce text data containing the text found in the video frame (image), which may be at a lower resolution, at say 480 pixel resolution, that leads to word loss and quality issues.

The output data from running OCR on the viewer computer system is compared to the OCR data received from the presenter computer system. Using a configurable threshold value, the two data objects, (which in an implementation may be JSON, a list of entries or other data format) are compared to count similarity of text found.

A threshold value is used to determine if the difference is significant, (e.g. 50% loss in OCR data in the viewer system). If it is significant, then the screensharing application can “fallback” to using a rendered, text-based display of the OCR text data it received from the presenter.

The display of the presenter's OCR data may be done in various ways, for example, as a text file on the screen or re-creating a mock of the presenter's screen making use of the x, y position of each text entry.

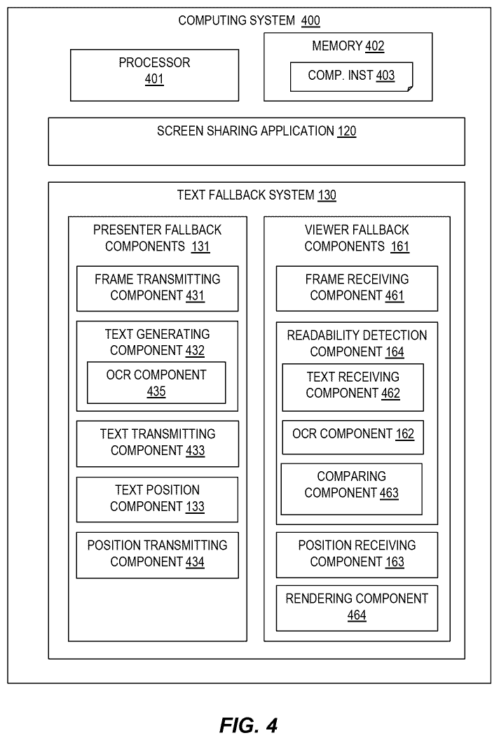

Referring to FIG. 4, a block diagram shows an example embodiment of a computing system 400 at which the described text fallback system 130 is provided. The text fallback system 130 may be provided as an integration into a screen sharing application 120.

The computing system 400 includes at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the text fallback system 130 and its components. The text fallback system 130 may be provided with components such that it can provide the functionality in the role of a presenter shown as presenter fallback components 131 or a viewer shown as viewer fallback components 161.

The presenter fallback components 131 include a frame transmitting component 431 for transmitting screen sharing frames to a receiving computer system. This may transmit the frames using the screen sharing application 120.

The presenter fallback components 131 include a text generating component 432 for generating text of a screen sharing frame, wherein the text may be generated by an OCR method provided or accessed by an OCR component 435 with the OCR applied to the frame before transmission or may be generated by access to the original text at the presenter computing system.

The presenter fallback components 131 include a text transmitting component 433 for transmitting the generated text in association with the screen sharing frame.

The presenter fallback components 131 include a text position component 133 for determining a position of the text elements in the screen sharing frame.

The presenter fallback components 131 include a position transmitting component 434 for transmitting the position of text elements in association with the text.

The viewer fallback components 161 include a frame receiving component 461 for receiving screen sharing frames from a remote computer system. This may receive the frames using the screen sharing application 120.

The viewer fallback components 161 include a readability detection component 164 for detecting a readability of text in a shared screen frame and determining if the readability in a shared screen frame is below a defined threshold. The readability detection component 164 monitors the readability of text in a shared screen frame.

The readability detection component 164 including a text receiving component 462 for receiving text of a received screen sharing frame, an OCR component 162 generating text of the received screen sharing frame, and a comparing component 463 for comparing the received text of the frame with the generated text to determine a readability measure of the received frame.

The viewer fallback components 161 include a position receiving component for receiving positions of text elements of the received screen sharing frame, where the positions of text elements are used in the output of text when a shared screen frame is below the defined threshold. The viewer fallback components 161 include a rendering component 464 for rendering an output of text of the shared screen as received from the remote computer system rendered with text elements with positions corresponding to the text elements in the screen sharing frame.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

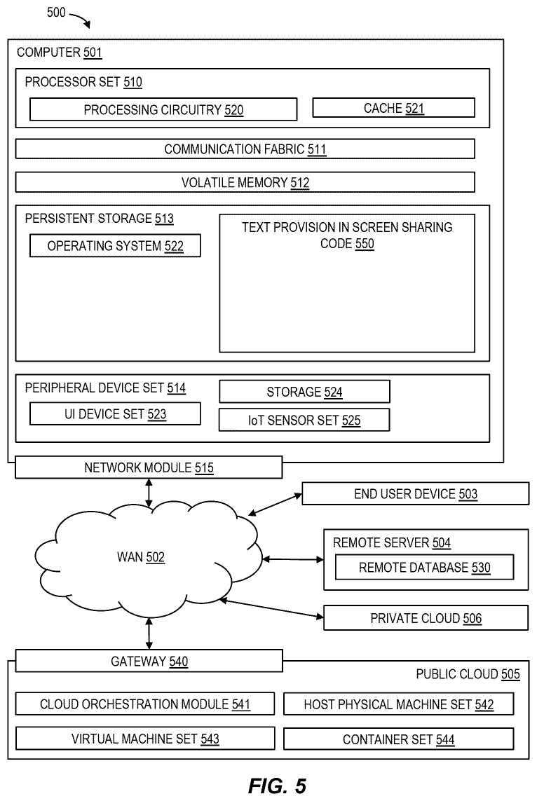

Referring to FIG. 5, computing environment 500 contains an example of an environment for the execution of at least some of the computer code involved in performing the inventive methods, such as text provision in screen sharing code 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for providing text in screen sharing, the computer-implemented method comprising:
receiving, by a processor of a computer system, screen sharing frames from a remote computer system;
detecting, by the processor of the computer system, a readability of text in a shared screen frame and determining if the readability in the shared screen frame is below a defined threshold; and
in response to determining that the shared screen frame is below the defined threshold, providing an output of text of the shared screen frame as received from the remote computer system.

2. The computer-implemented method of claim 1, including:
monitoring the readability of text in the shared screen frame and determining if the readability of text in the shared screen frame is above the defined threshold; and
in response to determining that the shared screen frame is above the defined threshold, displaying the shared screen frame and iterating the computer-implemented method.

3. The computer-implemented method of claim 1, including:
receiving text of a received screen sharing frame before transmission, and wherein the received text is used in determining the readability of the received screen sharing frame.

4. The computer-implemented method of claim 3, including:
generating text of the received screen sharing frame, wherein the text is generated by optical character recognition (OCR) applied to the received text of the received screen sharing frame; and
comparing the received text of the received screen sharing frame with the generated text to determine a readability measure of the received screen sharing frame.

5. The computer-implemented method of claim 4, wherein received text of the received screen sharing frame is received using the OCR used for generating the text of the received screen sharing frame.

6. The computer-implemented method of claim 4, wherein comparing the received text of the received screen sharing frame with the generated text to determine the readability measure of the received frame further comprises using a detected word count to provide the readability measure.

7. The computer-implemented method of claim 1, including:
receiving positions of text elements of the received screen sharing frame, wherein the positions of text elements are used in the output of text in response to determining that the shared screen frame is below the defined threshold.

8. The computer-implemented method of claim 7, wherein the received positions of text elements are coordinates in the received screen sharing frame and element height and width.

9. The computer-implemented method of claim 7, including receiving a text-based file with a plurality of entries with each entry having text and associated position data.

10. The computer-implemented method of claim 7, wherein providing the output of text of the shared screen frame as received from the remote computer system includes rendering the text in the output in the text elements with the positions corresponding to the text elements in the screen sharing frame.

11. The computer-implemented method of claim 1, further comprising, at the remote computer system:
transmitting the screen sharing frames to a receiving computer system;
generating text of a screen sharing frame and transmitting the generated text in association with the screen sharing frame; and
determining a position of text elements in the screen sharing frame and transmitting the positions of text elements with the generated text.

12. A system for providing text in screen sharing, comprising:
a viewer computer system having a processor and a memory configured to provide computer program instructions to the processor to execute a method of:
receiving screen sharing frames from a remote computer system;
detecting a readability of text in a shared screen frame and determining if the readability in the shared screen frame is below a defined threshold; and
in response to determining that the shared screen frame is below the defined threshold, providing an output of text of the shared screen frame as received from the remote computer system.

13. The system of claim 12, wherein the viewer computer system configured to provide the computer program instructions to the processor further includes the computer program instructions comprising:
monitoring the readability of text in the shared screen frame and determining if the readability in the shared screen frame is above the defined threshold; and
in response to determining that the shared screen frame is above the defined threshold, displaying the shared screen frame and iterating the method.

14. The system of claim 12, wherein the viewer computer system configured to provide the computer program instructions to the processor further includes the computer program instructions comprising:
receiving text of a received screen sharing frame, and
generating text of the received screen sharing frame, wherein the text is generated by OCR; and
comparing the received text of the received screen sharing frame with the generated text to determine a readability measure of the received screen sharing frame.

15. The system of claim 14, wherein comparing the received text of the received screen sharing frame with the generated text to determine the readability measure of the received screen sharing frame further comprises using a detected word count to provide the readability measure.

16. The system of claim 12, wherein the viewer computer system configured to provide the computer program instructions to the processor further includes the computer program instructions comprising:
receiving positions of text elements of the received screen sharing frame, wherein the positions of text elements are used in the output of text in response to determining that the shared screen frame is below the defined threshold.

17. The system of claim 16, wherein the received positions of text elements are reference coordinates in the received screen sharing frame and element height and width, and wherein providing the output of text of the shared screen frame as received from the remote computer system includes rendering the text in the output of text in the text elements with the positions corresponding to the text elements in the received screen sharing frame.

18. The system of claim 12, further comprising, at the remote computer system:
transmitting the screen sharing frames to a receiving computer system;
generating text of the screen sharing frame and transmitting the generated text in association with the screen sharing frame; and
determining a position of text elements in the screen sharing frame and transmitting the positions with the generated text.

19. The system of claims 12, wherein the system is integrated into a screen sharing application.

20. A computer program product, comprising:
one or more tangible computer-readable storage devices and program instructions stored on at least one of the one or more tangible computer-readable storage devices, the program instructions executable by a processor, the program instructions comprising:
receiving screen sharing frames from a remote computer system;
detecting a readability of text in a shared screen frame and determining if the readability in the shared screen frame is below a defined threshold; and
in response to determining that the shared screen frame is below the defined threshold, providing an output of text of the shared screen frame as received from the remote computer system.
